(19) United States
(12) Patent Application Publication
(10) Pub. No.: US 2008/0075376 A1
(43) Pub. Date: Mar. 27, 2008

(54) Iterative process with rotated architecture for reduced pipeline dependency

(76) Inventors: James Wilson, Foxboro, MA (US); Joshua A. Kablotsky, Carlisle, MA (US); Yosef Stein, Sharon, MA (US); Christopher M. Mayer, Dover, MA (US)

Correspondence Address: Iandiorio & Teska, 260 Bear Hill Road, Waltham, MA, 02451-1018, US

(21) Appl. No.: 11/527,001

(22) Filed: Sep. 26, 2006

(51) Int. Cl. G06K 9/36; G06K 9/46

(52) U.S. Cl. 382/247

(57) ABSTRACT

In a pipeline machine where, in an iterative process, one or more subsequent functions employ one or more parameters determined by one or more antecedent functions and the one or more subsequent functions generate one or more parameters for the one or more antecedent functions, pipeline dependency is reduced by advancing or rotating the iterative process by preliminarily providing to the subsequent function the next one or more parameters on which it is dependent and thereafter: generating by the subsequent function, in response to the one or more parameters on which is it dependent, the next one or more parameters required by the one or more antecedent functions and then, generating by the one or more antecedent functions, in response to the one or more parameters required by the one or more antecedent functions, the next one or more parameters for input to the subsequent function for the next iteration.

### FIELD OF THE INVENTION

This invention relates to an improved method and system of reducing in an iterative process pipeline dependency through rotated architecture and more particularly to such a method and system adaptable for arithmetic encoding/decoding applications e.g., H.264 CABAC, JPEG, JPEG2000, On2.

### BACKGROUND OF THE INVENTION

In a pipelined machine if an instruction is dependent on the result of another one, a pipeline stall will happen where the pipeline will stop, waiting for the offending instruction to finish before resuming work. This is especially a problem in iterative arithmetic coding processes such as JPEG2000, JPEG, On2, and in H.264 Context -based Adaptive Binary Arithmetic Coding (CABAC). For example H.264 CABAC is based on the principle of recursive interval subdivision. [For a fall description of the H264 CABAC standards and details see ITU-T Series H: Audiovisual and Multimedia Systems Infrastructure of audiovisual -coding of moving video] Given a probability estimation p(0) and p(1)=1−p(0) of a binary decision (0,1), an initially given interval or range will be subdivided into two sub-intervals having a range*p(0) and range-range*p(0), respectively. Depending on the decision, the corresponding sub-interval will be chosen as the new code interval, and a binary code string pointing to that interval will present the sequence of binary decisions. It is useful to distinguish between the most probable symbol (MPS) and the least probable symbol (LPS), so that binary decisions are identified as either MPS or LPS, rather then 0 or 1. According to H.264 CABAC process the range and state are used to access a two dimensional look-up table to determine the rLPS (range of least probable symbol). Current range is derived from the rLPS and the previous range. If the code offset (Value) is less than the current range, the Most probable path is taken where the most probable symbol (MPS) is designated as the next output bit, and the state transition is preformed based on the most probable symbol (MPS) look-up table. If Value is greater than current range, the Least probable path is taken where the MPS bit is inverted, the current Value is determined from the previous Value and the range then rLPS is assigned to range. Following this, if the state equals zero, the MPS is inverted. The next state transition is derived from the LPS state table based on the current state, followed by the renormalization process where the range is renormalized to 0x0100.Value is scaled up accordingly and the new LSB bits are appended from the bit stream FIFO. One problem with this is that determining the current range from the previous range and the rLPS has a dependency on the two dimensional state/range look-up of rLPS. Thus in a pipelined processor the decoding process can encounter a pipeline stall waiting on the 2D rLPS look-up table result.

### BRIEF SUMMARY OF THE INVENTION

It is therefore an object of this invention to provide an improved method and system for reducing pipeline dependency in processes in which a second or subsequent function depends on a parameter from a first or antecedent function and generates parameters on which the first or antecedent function is dependent.

It is a further object of this invention to provide such an improved method and system having lower power requirements and increased performance and efficiency in such processes e.g. CABAC.

It is a further object of this invention to provide such an improved method and system which is implementable in software in processors without additional dedicated hardware e.g., ASICs or FPGAs.

It is a further object of this invention to provide such an improved method and system which re-uses existing compute units.

It is a further object of this invention to provide such an improved method and system which enables speculative use of additional compute units to reduce pipeline dependency.

It is a further object of this invention to provide such an improved method and system which enables use of compute unit data path look-up tables.

The invention results from the realization that in a pipelined machine where in an iterative process, one or more subsequent functions employ one or more parameters determined by one or more antecedent functions and the one or more subsequent functions generate one or more parameters for the one or more antecedent functions, pipeline dependency can be reduced by advancing or rotating the iterative process by preliminarily providing to the subsequent function the next one or more parameters on which it is dependent and thereafter: generating by the subsequent function, in response to the one or more parameters on which is it dependent, the next one or more parameters required by the one or more antecedent functions and then; generating by the one or more antecedent functions, in response to the one or more parameters required by the one or more antecedent functions, the next one or more parameters for input to the subsequent function for the next iteration.

The subject invention, however, in other embodiments, need not achieve all these objectives and the claims hereof should not be limited to structures or methods capable of achieving these objectives.

This invention features in a pipelined machine where, in an iterative process, one or more subsequent functions employ one or more parameters determined by one or more antecedent functions and the one or more subsequent functions generate one or more parameters for the one or more antecedent functions, an improved method which includes advancing or rotating the iterative process by preliminarily providing to the subsequent function the next one or more parameters on which it is dependent. Thereafter there is generated by the subsequent function, in response to the one or more parameters on which is it dependent, the next one or more parameters required by the one or more antecedent functions. Then there is generated by the one or more antecedent functions, in response to the one or more parameters required by the one or more antecedent functions, the next one or more parameters for input to the subsequent function for the next iteration.

In a preferred embodiment the iterative process may be an arithmetic coding or decoding; it may be an H.264 CABAC decoder. The preliminarily provided one or more parameters on which the subsequent function depends may include rLPS. The one or more parameters required by the one or more antecedent functions may include the next range, next context and the antecedent function may generate the next rLPS. The one or more parameters required by the one or more antecedent functions may include next value, new context and the antecedent function may generate the new context next rLPS. The antecedent function may provide the next range, next value, next context. The one or more parameters required by the one or more subsequent functions may include, present range, present value, present context, and present rLPS. The one or more parameters provided by the one or more subsequent functions to the one or more antecedent functions may include arithmetic coding parameter update functions; or may include next value, next range, and next context. The subsequent functions may include H.264 CABAC parameter update functions. The antecedent functions may include range sub-division functions. The pipelined machine may include at least a one compute unit for executing the subsequent and antecedent functions. The pipelined machine may include at least a one compute unit for executing the subsequent and antecedent functions and at least a second compute unit for executing in parallel the antecedent function in response to the next value, next range, next rLPS and new context to provide the next rLPS for the new context. One of the next rLPS and next rLPS for the new context may be chosen for the next iteration and the other may be abandoned. The one or more parameters on which the subsequent function depends may include present value and present range and the one or more parameters it provides to the antecedent function may include the output bit. The one or more parameters which the antecedent function provides may include the next value. The preliminarily provided one or more parameters generated by the antecedent function may include the next value.

This invention also features in an arithmetic encoder or decoder performing, in an iterative process, one or more subsequent functions employing one or more parameters determined by one or more antecedent functions, the one or more subsequent functions generating one or more parameters for the one or more antecedent functions, an improved method including advancing the iterative process by preliminarily providing to the subsequent function the next one or more parameters on which it is dependent. Thereafter, there is generated by the subsequent function in response to the one or more parameters on which it is dependent, the next one or more parameters required by the one or more antecedent functions. Then there is generated by the one or more antecedent functions, in response to the one or more parameters required by the one or more antecedent functions, the next one or more parameters for input to the subsequent function for the next iteration.

This invention also features a pipelined machine for performing an iterative process wherein one or more subsequent functions employ one or more parameters determined by one or more antecedent functions and the one or more subsequent functions generates one or more parameters for the one or more antecedent functions. There is at least one compute unit for advancing the iterative process by preliminarily providing to the subsequent function the next one or more parameters on which it is dependent. There is at least a second compute unit for generating via the subsequent function in response to the one or more parameters on which it is dependent, the next one or more parameters required by the one or more antecedent functions and then generating via the one or more antecedent functions, in response to the one or more parameters required by the one or more antecedent functions, the next one or more parameters for input to the subsequent function for the next iteration.

In a preferred embodiment the second compute unit may subsequently execute the antecedent function in parallel with the first compute unit. The iterative process may involve a CABAC decoder/encoder. The preliminarily provided one or more parameters on which the subsequent function is dependent may include rLPS. The one or more parameters required by the one or more antecedent functions may include the next range and next context and the antecedent function may generate the next rLPS. The new context next rLPS may be generated by the first compute unit. The new context next rLPS may be generated by the second compute unit. The one of new context next rLPS and next rLPS may be chosen for the next iteration and the other may be abandoned.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is flow block diagram of a prior art method of performing H.264 CABAC decoding with unknown probabilities for MPS/LPS:

FIG. 2 is flow block diagram of a method of performing CABAC decoding with rotated architecture according to this invention;

FIG. 3 is a more generalized flow block diagram of the method with rotated architecture according to this invention;

FIG. 4 is a more detailed flow block diagram of the prior art method of CABAC decoding of FIG. 1;

FIG. 5 is a more detailed flow block diagram of the method of CABAC decoding of FIG. 2 according to this invention;

FIG. 6 is a more detailed flow block diagram of a parallel process for generating the new context next rLPS concurrently with the next rLPS;

FIG. 7 is a directory of FIGS. 7A and 7B which are schematic block diagram of an arithmetic processor with four compute units for implementing this invention;

FIG. 8 is a flow block diagram of a prior art method of performing CABAC decoding with equal probabilities for MPS/LPS; and

FIG. 9 is a flow block diagram of a method of performing CABAC decoding with equal probabilities for MPS/LPS using rotated architecture according to this invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

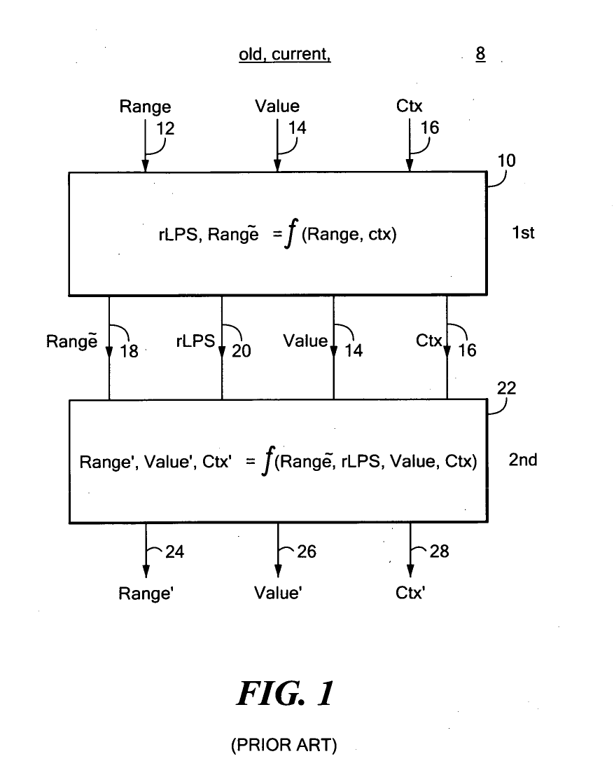

There is shown in FIG. 1 a routine or process 8 of CABAC decoding such as in H.264. A first or antecedent function 10 responds to present range 12, value 14, and context [State,MPS]16 to calculate rLPS and intermediate range˜. First or antecedent function 10 then provides the intermediate range˜18, rLPS 20, the present value 14, and context 16 to the second or subsequent function 22. Function 22 generates the next range, range′, the next value, value′, and the next context, context′. One problem with this prior art implementation is that before the second or subsequent function 22 can be run, intermediate range ˜18 and rLPS 20 have to be calculated by the first or antecedent function 10. In pipelined machines this means that function 22 is dependent on function 10 and subject to pipeline stall, delays. This is so because for each time, before function 22 can execute, it must wait on function 10 performing the necessary operations to generate intermediate ranged ˜18 and rLPS 20.

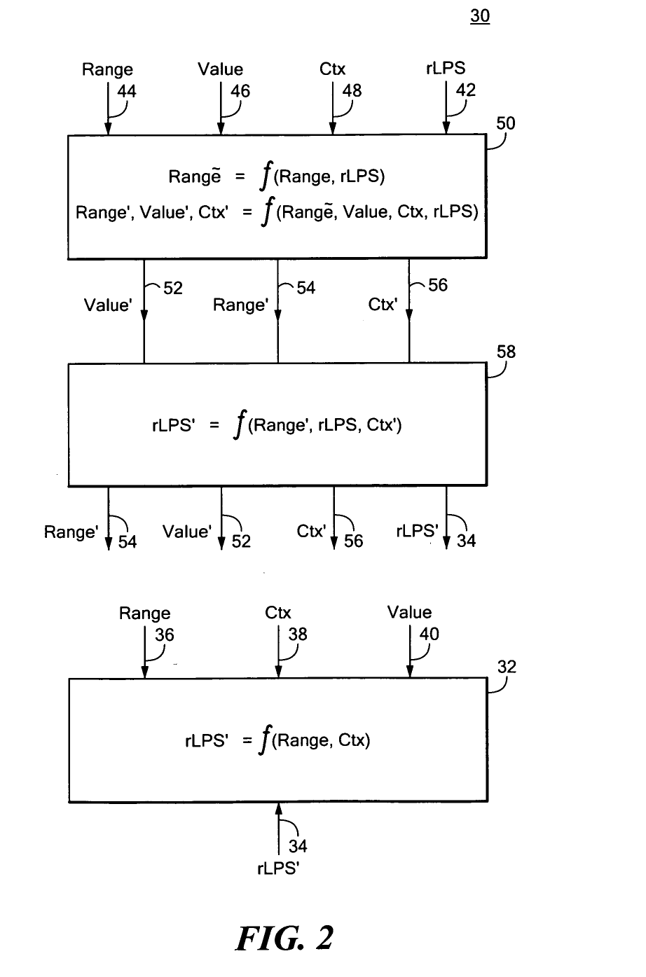

In accordance with this invention, routine or process 30, FIG. 2, rotates or advances the iterative process or routine by preliminarily providing to the subsequent function the one or more parameters on which is it dependent and then generating by the subsequent function in response to those parameters one or more parameters required by the antecedent functions and then generating via the one or more antecedent functions in response to its required parameters, one or more parameters input to the subsequent function for the next iteration. Thus, the iterative process is rotated by preliminarily 32 generating the next rLPS, rLPS′ at 34 from the present range 36, context 38, and value 40. This next rLPS′ 34 becomes the present rLPS 42 as provided in conjunction with the present range 44, value 46 and context 48 to the second or subsequent function 50 resolving in function 50 the dependency of current range on the two dimensional state/range look-up table of rLPS. From this, subsequent function 50 generates the next value′ 52, updated next range′ 54 and updated next context′ 56. Then the first or antecedent function 58 calculates the next iteration rLPS′ from the next range′ and next context′ thereby resolving the dependency of next iteration range on the 2D look-up table of rLPS. The rotation of the architecture has been effected by generating with the antecedent function at the end of this iteration, the inputs needed by the subsequent function in the next iteration. The output of first or antecedent function 58 is then next range′ 54, next value′ 52, next context′ 56 and the next iteration rLPS′ 34 so that the dependency on the 2D LUT of rLPS of the evaluation of the intimidate range˜ of the next iteration of function 50 is resolved.

In terms of the CABAC implementation of this specific embodiment the first or antecedent function 58 is the range subdivision function and the second or subsequent function 50 is the CABAC parameter update.

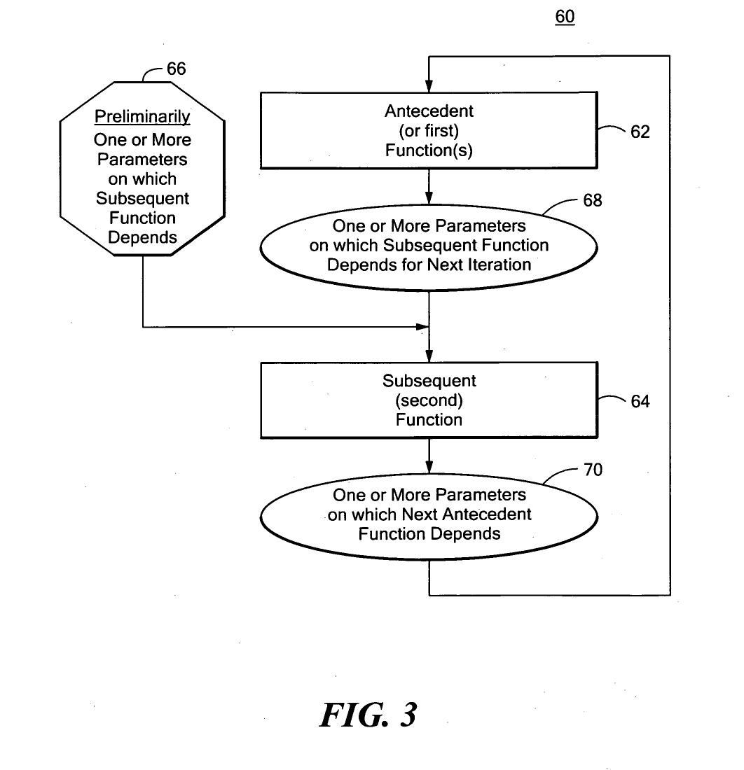

While FIG. 2 is explained with regard to a CABAC decoding application, this is only one embodiment of the invention. This invention is applicable to e.g. H.264 CABAC encoding/decoding as well as arithmetic coding in JPEG2000, JPEG, On2 and many other encoding and decoding applications. Even more generally the invention contemplates that for any process 60, FIG. 3, having an antecedent or first function 62 and a subsequent or second function 64, the process operation or architecture can be rotated so that initially, preliminarily 66 one or more parameters on which the subsequent function depends are generated and delivered directly to the subsequent function 64 which then generates one or more parameters 70 on which the antecedent function depends. Antecedent function 62 then determines the one or more parameters 68 on which the subsequent function depends for the next iteration. In this way at the end of each iteration the necessary parameters for the subsequent function are already generated and await only new inputs that don't have to be determined.

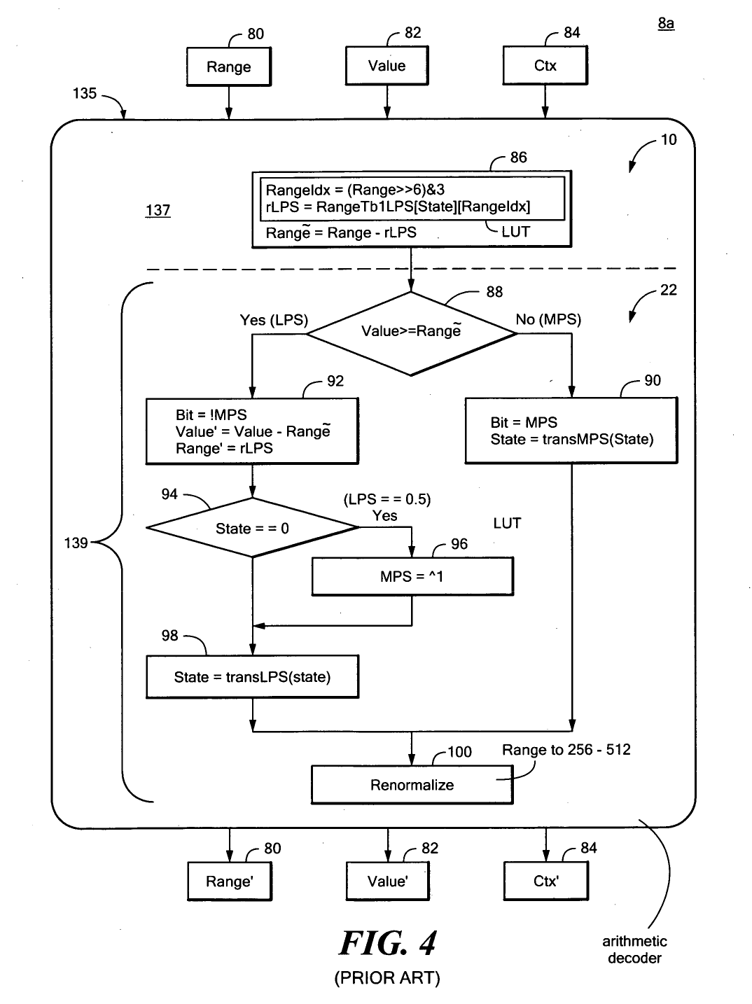

Prior art CABAC process 8a, FIG. 4, receives three inputs, present range 80, value 82, and context 84. In the first step 86, rLPS and intermediate range˜ are calculated. rLPS is typically generated using a look-up table in an associated compute unit. In step 88 it is determined as to whether value is greater than the intermediate range˜. If it is not greater than the intermediate range˜, the Most probable symbol path is taken where in step 90 MPS is assigned as the output bit and the state of the context is updated using a second look-up table (the MPS-transition table). If the value is greater that the range the Least probable symbol path is taken where in step 92 an inverted MPS is assigned as the output bit, the next value is calculated from the value and the intermediate range˜ and the next range is determined from the rLPS. Following this in step 94, if the state is equal to zero the MPS is negated in step 96. If state is not equal to zero following step 94, or following step 96, a new state is determined 98 from a third look-up table (the LPS-transition table). Finally, whether the value is greater than or less than the range, the respective outputs are renormalized 100 to a range between 256 and 512, the Value is scaled up accordingly and the new LSB bits of Value are appended from the bit stream FIFO. The outputs resulting then are the normalized next range, range′, normalized next value, value′, and next context, context′. The operation of process 8a is effected by arithmetic encoder/decoder 135. The first portion is the first or antecedent function 10, FIG. 1, implementing the CABAC range subdivision function 137, FIG. 4, the second portion is the second or subsequent function 22, FIG. 1, implementing the CABAC parameter update function 139. As can be seen at 137 the evaluation of range˜ must stall until the two dimensional state/range look-up table of rLPS result is resolved.

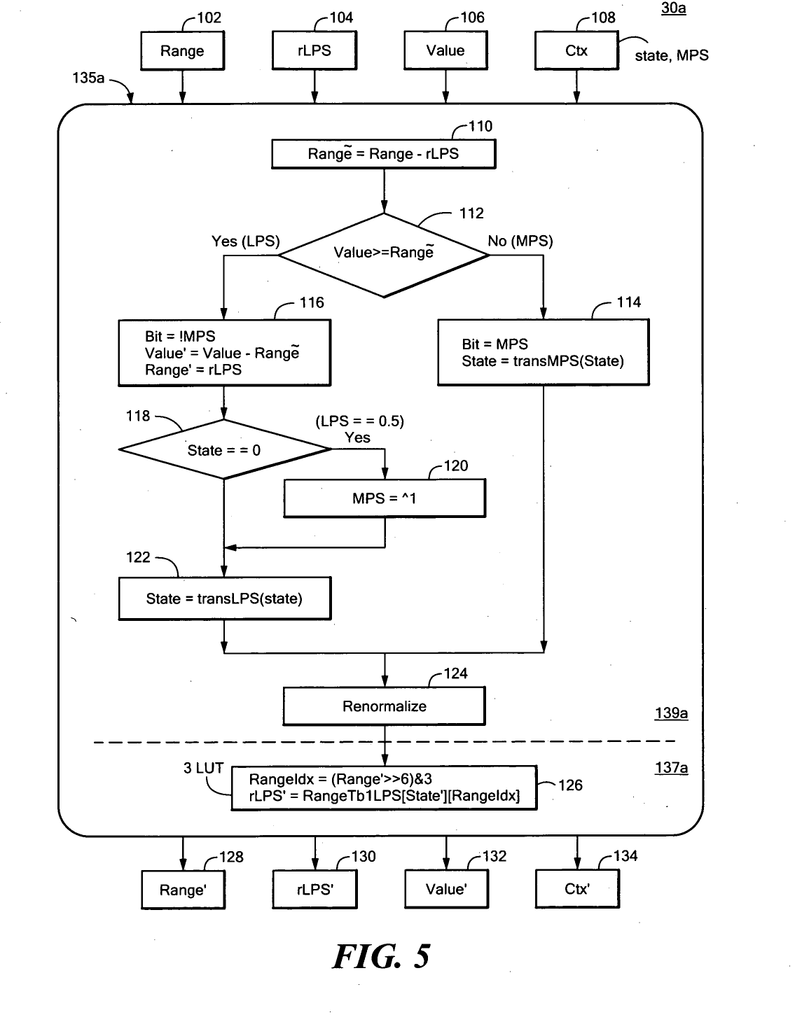

In contrast CABAC decoder processor 30a in accordance with this invention, FIG. 5, has four inputs, present range, 102, present rLPS 104, present value 106, and present context 108. In the process 30a according to this invention the present rLPS 104 is supplied either externally as in step 32 in FIG. 2 initially, and then once the operation is running, by the preliminary generation of the next rLPS′ by the antecedent or first function 58, FIG. 2. With the rLPS being supplied preliminarily in either case the dependency of range˜ on the two dimensional state/range look-up table of rLPS result is resolved, and the intermediate range˜ is determined from the present range and the present rLPS in step 110. Then in step 112 it is determined whether the value is greater than the intermediate range, if it is not, once again the Most probable symbol path is taken where in step 114 the MPS is assigned to a bit and the state of the context is updated by reference to a first MPS-transition look-up table. If the value is greater than the intermediate range then the Least probable symbol path is taken where MPS has assigned to it the inverted bit, next value′ is determined from present value and intermediate range˜ and the next range′ is determined from the rLPS. In step 118 inquiry is made as to whether the state is equal to zero. If it is the MPS is negated in step 120. In step 122 the new context state is determined from a second LPS-transition look-up table. In either case in step 124 the system is renormalized as previously explained. Then the first or antecedent function 126 occurs: that is the first two operations in step 86 of the prior art device, FIG. 4, are now performed after the subsequent functions. There in step 126 the next rLPS, rLPS′ is determined from the range/state using a third 2D look-up table. The output then is the next range, range′ 128 the next rLPS, rLPS′ 130, the next value, value′ 132, and the next context, context′ 134. The operation of process 30a is effected by arithmetic decoder 135a. The first portion is the second or subsequent function 50, FIG. 2, implementing the CABAC parameter update function 139a; the second portion is the first or antecedent function 58, FIG. 2, implementing the CABAC range subdivision function 137a.

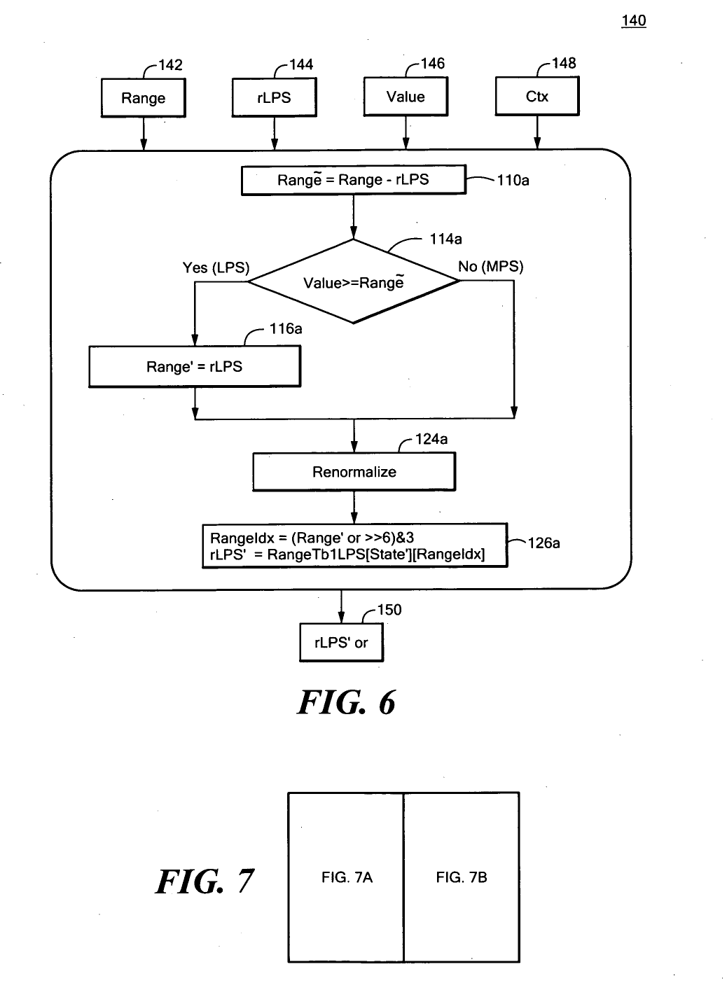

Note that the next rLPS′, which is anticipatorily generated in the methods of this invention shown in FIGS. 2 and 5, is based on a particular context value. As long as this context is going to be used in the next iteration the anticipatory next rLPS, rLPS′ being calculated in advance is proper. However, occasionally context itself may change in which case a new context next rLPS′ or, rLPS″ will have to be created for the new context. This is accommodated by an additional routine or process 140, FIG. 6, which may operate in parallel with the method or process 30a, FIG. 5. In FIG. 6, the present range 142, rLPS 144, value 146, and new context 148, are provided and process 140 generates the new context next rLPS, rLPS″ 150 so that even though the rLPS′ 130, FIG. 5, generated from the old context 108 is improper the new context next rLPS″ 150 will be ready for the preliminary use. Only one of rLPS′ and rLPS″ will be chosen to be used; the other will be abandoned.

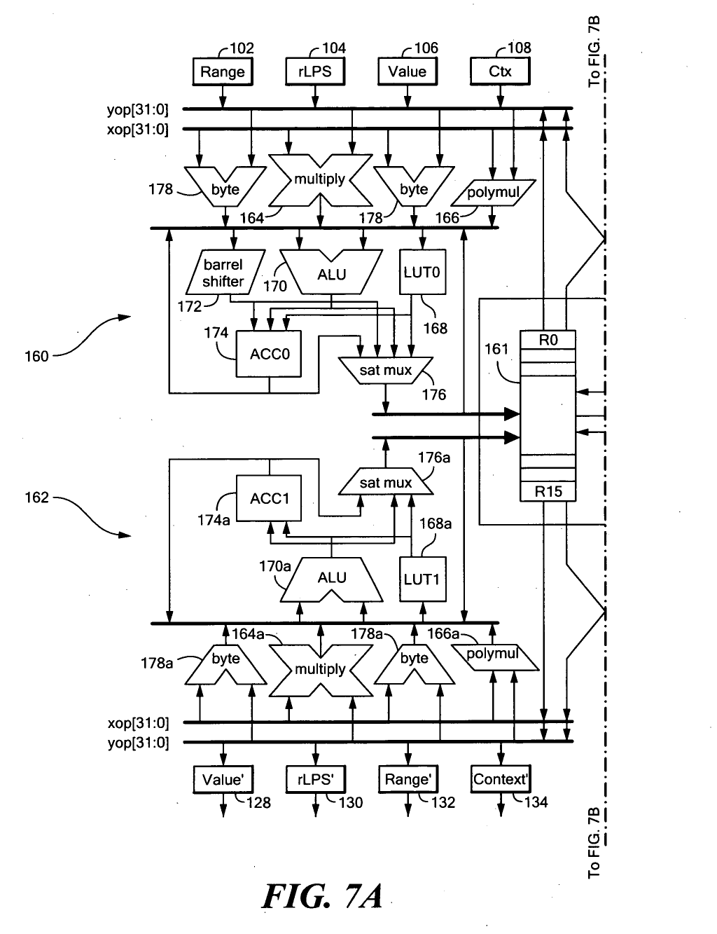

Process 30a, FIG. 5, may be implemented in a pair of compute units 160, 162, FIGS. 7A and 7B, each including a variety of components including e.g., multiplier 164, polynomial multiplier 166, look-up table 168, arithmetic logic unit 170, barrel shifter 172, accumulator 174, mux 176, byte ALUs 178. Compute units 160, 162 perform the method or process 30a of FIG. 5, and look-up tables 168, 168a fill the role of the necessary look-up tables in steps 114, 122, and 126 referred to in FIG. 5. A second set of compute units 160′, 162′ having the same components can be used operating in parallel on the same inputs range 102, rLPS 104, value 106, and context 108 where the context can be a new context to provide at the output a new context next rLPS, rLPS″ 180. Compute units 160, 160′ 162, 162′ are accessed through registers 161 and 163.

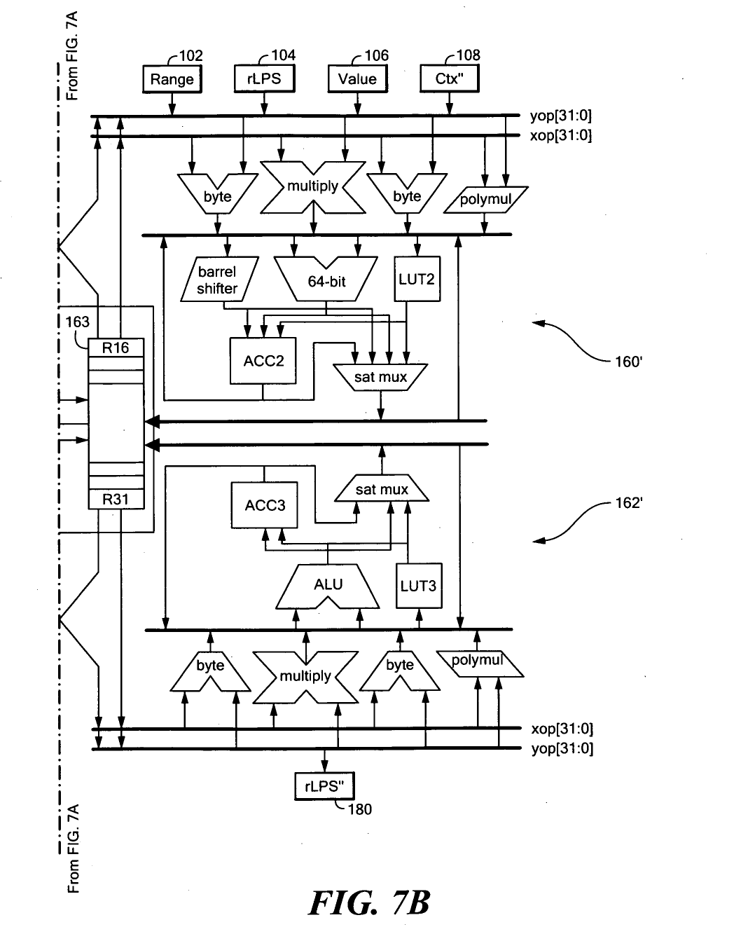

While thus far the explanation has been with respect to situation where the probability between the LPS and MPS is not known, there are cases where the probability of LPS to MPS is equal e.g. 50%. In that case the first or antecedent function 200, FIG. 8, responds to value 202, and range 204 to provide next value′ 206 and the second or subsequent function 208 responds to the next value′ 206, to determine the output bit and range to provide the output bit 210 and the next value′ 206 output. Again here the second or subsequent function 208 is dependent on the completion of the first or antecedent function 200 and in a pipelined machine that dependency can result in delays due to pipeline stall because the next value, value′ required by second or subsequent function 208 must be determined in the first or antecedent function 200 using the inputs of present value 202 and range 204.

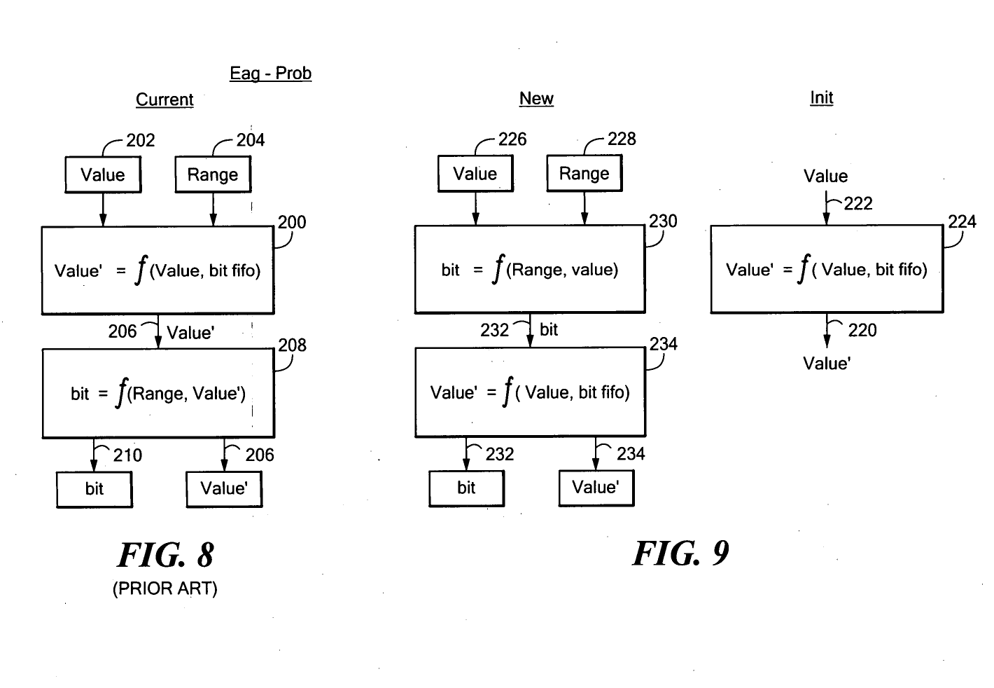

In accordance with this invention once again the architecture can be rotated so that initially, preliminarily, FIG. 9, the next value′ 220 can be determined from the present value 222 in step 224. Then with the next value, value′ 220 presented as the present value 226 along with range 228, the second or subsequent function 230 can execute immediately to determine the next bit 230. Then the first or antecedent function 234 can pass through the bit 232 and calculate the next value, value′ and have it ready preliminarily for the next iteration 234 where it will appear as the present value at 226.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. In a pipelined machine where, in an iterative process, one or more subsequent functions employ one or more parameters determined by one or more antecedent functions and the one or more subsequent functions generate one or more parameters for said one or more antecedent functions an improved method comprising:
advancing the iterative process by preliminarily providing to said subsequent function the next said one or more parameters on which it is dependent and thereafter:
generating via the subsequent function, in response to said one or more parameters, on which it is dependent, the next one or more parameters required by said one or more antecedent functions and then;
generating via the one or more antecedent functions, in response to said one or more parameters required by said one or more antecedent functions, the next one or more parameters for input to the subsequent function for the next iteration.

2. The method of claim 1 in which said iterative process is an arithmetic coding decoding or encoding.

3. The method of claim 2 in which said iterative process is an H.264 CABAC decoder.

4. The method of claim 3 in which the preliminarily provided said one or more parameters on which said subsequent function is dependent includes rLPS.

5. The method of claim 4 in which said one or more parameters required by said one or more antecedent functions include the next range, and next context and said antecedent function generates the next rLPS.

6. The method of claim 5 in which said one or more parameters required by said one or more antecedent functions includes the next new context value and said antecedent function generates the new context next rLPS.

7. The method of claim 5 in which said antecedent function further provides the next range, next value and the next context.

8. The method of claim 3 in which said one or more parameters required by said one or more subsequent function includes present range, present value, present context and present rLPS.

9. The method of claim 8 in which said one or more parameters provided by said one or more subsequent functions includes next value, next range and next context.

10. The method of claim 1 in which said subsequent functions include arithmetic coding parameter update functions.

11. The method of claim 8 in which said subsequent functions include H.264 CABAC parameter update functions.

12. The method of claim 8 in which said antecedent functions include range subdivision functions.

13. The method of claim 8 in which said pipeline machine includes at least one compute unit for executing said subsequent and antecedent functions.

14. The method of claim 5 in which said pipeline machine includes at least one compute unit for executing said subsequent and antecedent functions and at least a second compute unit for executing in parallel said antecedent function response to the next value next range, next rLPS and new context to provide said next rLPS for the new context.

15. The method of claim 14 in which only one of said next rLPS and next rLPS for the new context will be chosen for the next iteration and the other will be abandoned.

16. The method of claim 3 in which the one or more parameters on which said subsequent functions depends includes a present value and present range and the one or more parameters it provides to said antecedent function includes the output bit.

17. The method of claim 16 in which the one or more parameters which said antecedent function includes the next value.

18. The method of claim 17 in which the preliminarily provided one or more parameters generated by said context function includes the next value.

19. In an arithmetic encoder or decoder performing, in an iterative process one or more subsequent functions employing one or more parameters determined by one or more antecedent functions and the one or more subsequent functions generate one or more parameters for said one or more antecedent functions an improved method comprising:
advancing the iterative process by preliminarily providing to said subsequent function the next said one or more parameters on which it is dependent and thereafter:
generating via the subsequent function, in response to said one or more parameters on which it is dependent, the next one or more parameters required by said one or more antecedent functions and then;
generating via the one or more antecedent functions, in response to said one or more parameters required by said one or more antecedent functions, the next one or more parameters for input to the subsequent function for the next iteration.

20. A pipelined machine for performing an iterative process wherein one or more subsequent functions employ one or more parameters determined by one or more antecedent functions and the one or more subsequent functions generate one or more parameters for said one or more antecedent functions comprising:
at least one compute unit for advancing the iterative process by preliminarily providing to said subsequent function the next said one or more parameters on which it is dependent;
at least a second compute unit for thereafter generating via the subsequent function, in response to said one or more parameters on which it is dependent, the next one or more parameters required by said one or more antecedent functions and then generating via the one or more antecedent functions, in response to said one or more parameters required by said one or more antecedent functions, the next one or more parameters for input to the subsequent function for the next iteration.

21. The pipelined machine of claim 20 in which said second compute unit subsequently executes said antecedent function in parallel with said first compute unit.

22. The pipelined machine of claim 21 in which said iterative process is a CABAC decoder/encoder.

23. The pipelined machine of claim 22 in which the preliminarily provided said one parameters on which said subsequent function is dependent includes rLPS.

24. The pipelined machine of claim 23 in which said one or more parameters required by said one or more antecedent functions include the next range, and next context and said antecedent function generates the next rLPS.

25. The pipeline machine of claim 23 in which said next rLPS is generated by said first compute unit.

26. The pipeline machine of claim 25 in which said new context next rLPS is generated by said second compute unit.

27. The pipeline machine of claim 26 in which one of new context next rLPS and next rLPS is chosen for the next iteration and the other is abandoned.
